(19) United States
(12) Patent Application Publication
(10) Pub. No.: US 2003/0090233 A1
(43) Pub. Date: May 15, 2003

(54) Renewable stored energy power generating apparatus

(76) Inventor: David S. Browe, Fort Myers, FL (US)

Correspondence Address: David S. Browe, 26250 Schooner Drive, New Lenox, IL, 60451, US

(21) Appl. No.: 10/073,582

(22) Filed: Feb. 12, 2002

Related U.S. Application Data
(60) Provisional application No. 60/337,549, filed on Nov. 13, 2001.

(51) Int. Cl. H02J 7/00

(52) U.S. Cl. 320/101

(57) ABSTRACT

A renewable stored energy power generating apparatus includes a rechargeable battery supply and a device for collecting renewable energy and transforming that energy into an electrical charge that is transmitted to the rechargeable battery supply. The battery supply provides electrical power to operate the pump of a water filtration system. The batteries also provide auxiliary electrical in either alternating current or direct current form. The operating components are contained in a container which permits the apparatus to be conveniently sold, transported, stored but ready for use as soon as the renewable energy power source in the form of solar panels are deployed. The solar energy panels may be deployed on top of the container or remote therefrom. An ultra violet radiation device may be added to 100% assure no bacteria is alive after the water is filtered.

### CROSS REFERENCE TO RELATED APPLICATION

This application is the utility application of a provisional application having the Ser. No. 60/337,549 filed on Nov. 13, 2001.

### FIELD OF THE INVENTION

This invention relates to a renewable stored energy power generating apparatus and particularly to a system for collecting and storing renewable energy such as solar or wind power and using such energy when needed for water purification and/or as an auxiliary electrical power source.

### BACKGROUND OF THE INVENTION

During severe storms and other natural disasters, conventional supplies of clean water and electrical power may be disrupted. Solar and wind powered generators have been used to provide auxiliary electrical power. However, these systems have not been available in a compact, conveniently portable package that is relatively inexpensive and easy to store when not in use. Most importantly is the fact that the stored system can easily be set up again once the need arises. Conventional auxiliary power systems are often quite cumbersome and inconvenient for the individual homeowner and small business operator to install and operate.

Fossil fuel powered generators have also been used to provide back-up power. These devices require that gasoline or other fuel to be purchased and stored. Such generators can be noisy and smelly to operate. Additionally, gasoline presents a risk of explosion and fire.

In addition to the forgoing limitations of known auxiliary power systems, no renewable energy system is currently available for purifying water in addition to providing electrical power. During an emergency, it may be critically important to have ready excess to purified water, as well as back-up electrical power. an auxiliary source of stored, renewable energy would help to meet this need. A convenient, easy to use auxiliary power source that is widely available to the average homeowner and small business would also help to reduce the strain on the power company grid during emergencies and periods of high power consumption. If sufficient renewable power is produced, excess power could even be sold back to the utility company. This would provide considerable cost savings to the power user.

### SUMMARY OF THE INVENTION

It is therefore an object of the present invention to provide a renewable stored energy power generating apparatus that serves as convenient, compact source of auxiliary electrical power.

It is therefore another object of this invention to provide a renewable stored energy power generating apparatus that permits the users to quickly and reliably produce auxiliary power during emergencies, power shortages or power outages and at other times when such auxiliary power is required or desired.

It is a further object of this invention to provide an apparatus for effectively producing auxiliary power that may be used to purify and/or as an auxiliary AC or DC electrical power source.

It is a further object of this invention to provide an apparatus that effectively supplements the user's electrical power needs by employing renewable (e.g. wind or solar) energy sources and which therefore increases energy efficiency, reduces the user's power costs and lessens strain on the utility company's power grid.

It is a further object of this invention to provide a renewable stored energy power generating apparatus that is conveniently packaged as a compact commercially available unit.

It is a further object of this invention to provide a renewable stored energy power generating apparatus that is conveniently portable and easy to store when not in use.

It is still a further object of this invention to provide a renewable stored energy power generating apparatus that is particularly convenient and efficient for use by homeowners and operators of small businesses.

This invention features a renewable stored energy power generating apparatus including a way for collecting renewable energy and transforming that energy into an electrical charge, which charge is transmitted to one or more storage batteries. The storage batteries provide auxiliary power, when required, for one or more desired uses. For example, the auxiliary power may operate a pump and fresh water purification system. The power derived from the batteries may also be employed as a 12-Volt DC power source and/or it may be converted to alternating current and thereby serve as an AC power source.

In a preferred embodiment, the source for collecting and transforming the renewable energy may include one or more solar panels. A conventional wind generating system may also be used. Each battery may comprise a 12-Volt storage battery that is interconnected to the renewable energy collector through a charge controller. The storage batteries may be connected to one or more 12-Volt DC outlets. Various direct current appliances may be attached to such outlets. The batteries may also be connected to one or more 110-Volt AC outlets by way of a converter that converts the direct current of the storage batteries into an alternating current.

The water filtration system may include a water inlet that is connected through a first conduit segment to an inlet of the pump. The pump may also include an outlet that is connected through a second conduit segment to an inlet of a fresh or salt water filter. The water filter may also include an outlet that is connected through a third conduit segment to a water dispensing apparatus. A water holding tank may also be communicably interconnected to the outlet of the filter for storing water therein.

The water filtration system may further include a holding tank for receiving water to be filtered and for accommodating such water until it is drawn through the first and the second conduit segments and delivered to the filter by selective operation of the pump. The filter may include a pre-filter and a post-filter. The fresh water filter may comprise a reverse osmosis filtration system. A desalination filter may also be employed in lieu of, or addition to, the fresh water filter.

An enclosure or a complete container may be provided for accommodating each of the components specified above when those components are not in use. enclosure may be mounted to a support surface in a stationary manner or in the case of a container wheels may be or may not be added to facilitate the movement of the container as a unit. Typically, the apparatus is deployed by removing the solar panels and connected wiring from the enclosure or the movable container and mounting them in a desired location, that is, on a roof top or a preferred outdoor location.

### BRIEF DESCRIPTION OF THE DRAWINGS

FIG. 1 is a schematic layout of the operational components of the apparatus;

FIG. 2 is a blown-up view of one individual component in FIG. 1;

FIG. 3 shows the stand-up container containing all the components when not in use.

FIG. 4 is an exploded view of a container involving various parts.

### DETAILED DESCRIPTION OF THE INVENTION

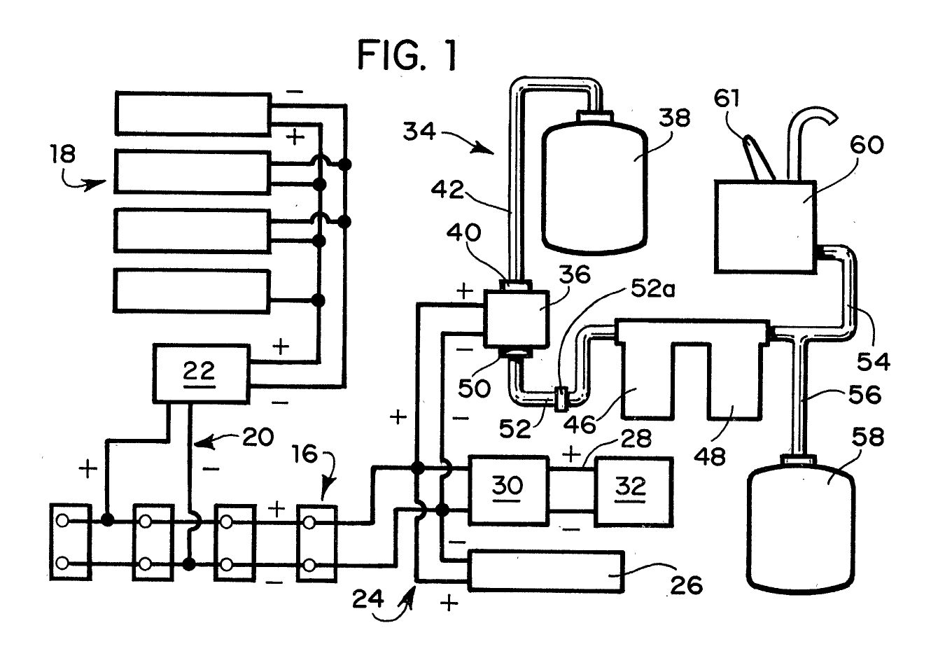

There is shown in FIG. 1 an illustration of the operational components of an apparatus which are depicted schematically. In particular, the power generating apparatus includes a plurality of 12-Volt DC storage batteries 16. These may comprise automobile or similar types of rechargeable storage batteries. A single battery or multiple batteries may be utilized. Various voltages may be employed.

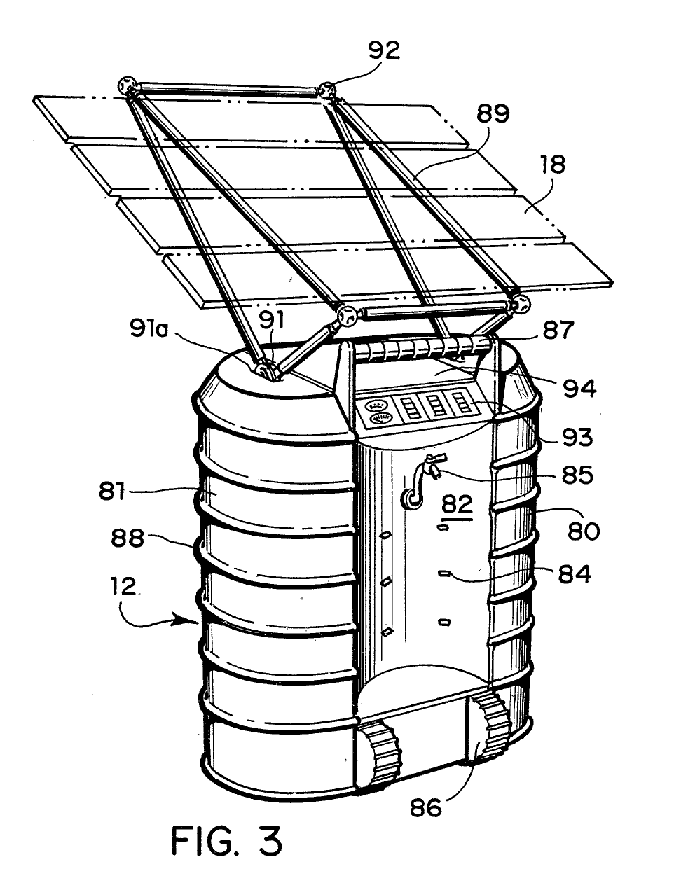

Renewable power, such as solar, is collected and provided to the batteries 16 by a plurality of solar panels 18. These panels 18 are attached to the container 12, FIG. 3, when the apparatus is packaged or self-contained for sale or while it is being stored or transported. During use or when getting ready for use, the solar panels 18 are disconnected from the enclosure or the container 12 and are deployed in an appropriate outdoor location. This may include mounting the panels on a roof top or any other conveniently accessible location that receives optimal amounts of sunlight/daylight. In the version disclosed, four 15-watt panels are utilized. Other numbers of solar panels or collectors may be employed within the scope of this invention. Additionally, the panels may have assorted power ratings. Each panel is connected to the bank of batteries through appropriate electrical wiring 20. A charge controller 22 is interconnected to the wiring between solar panels 18 and batteries 16. The solar power collected by the panels is converted or transformed to an appropriate electrical charge, which in turn, is delivered by the charge controller 22 to batteries 16 so that they recharge and store the renewable power as electrical energy. The precise manner of electrically interconnecting the solar panels to the batteries so that the batteries are recharged by the solar panels and store the electrical energy, which is conventional, and may be altered within the scope of the invention.

Batteries 16 provide auxiliary energy for one or more purposes. For example, the batteries may be interconnected through wiring 24 to a DC outlet 26 such that a 12-Volt DC power source is provided. A pair of such DC outlets 26 are shown at the side of the enclosure or container 12 in FIG. 3. An appliance requiring DC power may be connected to outlets 26 and thus be operated by the stored power.

Alternatively, battery 16 may be connected through wiring 28 and AC converter 30 to an alternating current outlet 32. The converter 30 may comprise a 1000-Watt, 110 Volt converter. Other comparable devices may be employed for converting the direct current of batteries 16 to alternating current. Assorted AC appliances may be engaged with outlet 32 which serves as a 110 VAC electrical power source. Each of the outlets 32 should be on the exterior of the enclosure or container to be conveniently accessible to the user. In other versions, the alternating current voltages other than 110-Volt, such as 240 Voltage AC may be provided.

Battery 16 may also provide auxiliary electrical power for driving a water filtration system 34. The water filtration system includes a 12-Volt DC pump, which may comprise a Shureflow™ diaphragm pump 36 or a similar pump as will be known to persons skilled in the water filtration industry. Various alternative types of pumps may be employed within the scope of the invention. The filtration system further includes a three gallon fresh water holding tank 38 that is communicably interconnected to an input port 40 of pump 36 by a first conduit segment 42. The conduit segment 42 may comprise a ⅛″ pump feed water line. The water line is typically composed of plastic material. Various alternative diameter and lengths may be utilized. The holding tank may have alternative holding capacities either less or greater than three gallons. It should be understood that in alternative embodiments the filter inlet may be attached directly to a conventional water line providing water from a utility or municipality. In this way the user may alternate between alternate water sources. A valve 15a may also be employed to selectively alternate between a holding tank and a water service line.

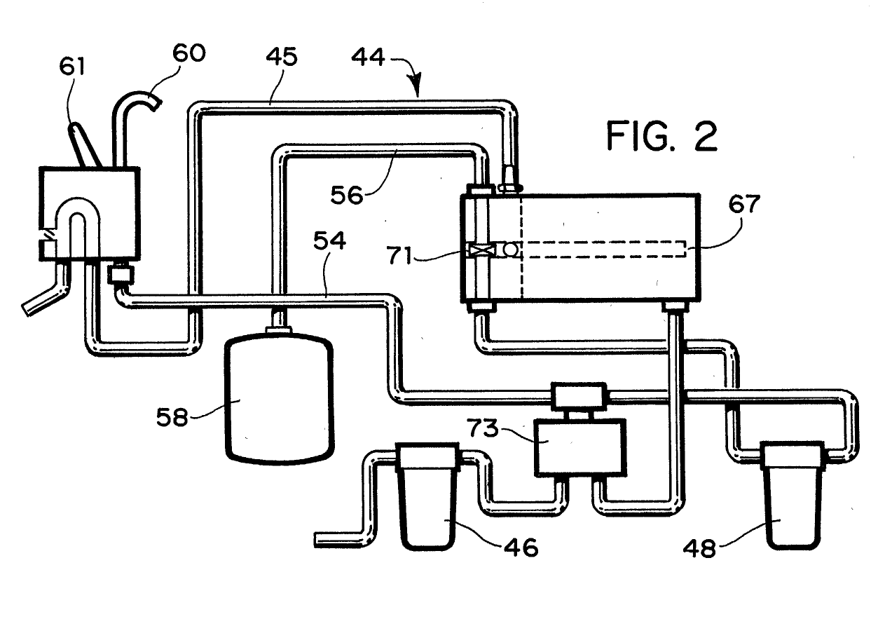

The filtration system 34 further includes a reverse osmosis filter 44, shown alone in FIG. 2. This filter may include a pre-filter and a post-filter 46 and 48, respectively. A Sears™ brand reverse osmosis filter or a comparable filtration unit may be utilized within the scope of this invention. Indeed, a wide variety of water purification systems may be employed. In certain embodiments, a conventional desalination unit may be employed in lieu of or in addition to filter 44. In the version depicted in FIG. 1, the input of filter 44 is interconnected to the outlet port 60 of pump 36 by a second conduit segment 52. This conduit segment may be identical or analogous to the water line 42 previously described. The outlet of the filter 44 is connected to a third conduit segment 64, which again may comprise a standard plastic water line. A fourth conduit segment 56 is interconnected to segment 54 (such as through a standard T-connector, not shown). Segment 56 terminates in a 2.3 gallon holding tank 58. The holding tank 58 may have various other capacities within the scope of the invention. Conduit segment 54 terminates in a standard water dispenser 60 or faucet.

When the apparatus is not in use, it remains stored in the condition as shown in FIG. 3. Al of the components depicted in FIGS. 1 and 2 may be accommodated conveniently on or within the enclosure or container 12. To utilize the apparatus, container 12 is opened. The solar panels 18 are removed from the enclosure and deployed in a desired location. The solar collectors may remain in the deployed condition and location when the apparatus is not in use so that apparatus 10 may be operated quickly and conveniently when needed. Solar panels 18 receive renewable power in the form of solar energy and that power is converted to an electrical charge that is stored in rechargeable batteries 16. The energy stored in the batteries is provided, as required, to DC outlets 26 and AC outlets 32 and appropriate direct current and alternating current appliances may be attached to those outlets and utilized as needed.

The batteries also provide power to pump 36 of the water filtration system 34. The pump is activated by operating a conventional switch (not shown). Initially, the fresh water to be purified is deposited into holding tank 38 located within the enclosure 12. Activating pump 36 causes the water to be drawn through water line 52 at an average pressure of about 45 PSI. The water is pumped through pre-filter 46 which removes dirt, sediment and chlorine. The pre-filtered water is forced through an R/O (reverse osmosis) membrane 67 (FIG. 2), which removes dissolved solids and organic matter in a conventional manner. About ⅚th of the water pumped into membrane 67 is rejected and drained through the line 45. The remaining filtered water is delivered either to tank 53 through water lines 56 or to the dispenser 60 through post-filter 48 and line 54. The post-filter 48 comprises a carbon type filter that removes remaining tastes and odors from the product water. When filtered water is required, the user operates dispenser 60 in a known manner (that is, by pivoting lever 61) such that the water is drawn from the holding tank and through lines 56 and 54 to the dispenser 60. Water is then dispensed. Water is then dispensed into an appropriate container.

Reverse osmosis filter system 44 includes several other standard features that are shown in FIG. 2. For example, a check valve 71 is located proximate the outlet of the R/O membrane 67. This membrane comprises a cartridge mounted inside a housing. Check valve 71 is located in the outlet of R/O housing. The check valve prevents a reverse flow of the product water from storage tank 58 into the R/O membrane 67. An automatic shutoff valve assembly 73 responds to a sensor (not shown) detecting that the holding tank 58 is filled to capacity. When this condition is sensed and water faucet 60 is closed, the back pressure in line 54 causes automatic shutoff valve 73 to close so that the flow of water into the R/O membrane is stopped. After faucet 60 is opened and pressure within line 54 is relieved, automatic shutoff valve will open to resume the flow of water into the membrane 67.

Drain 45 is connected adjacent faucet 60 and an appropriate air gap is provided to comply with standard plumbing codes. A drain flow control 90 regulates the water flow through R/O membrane 67. This device, which will be known to persons skilled in this art, maintains a desired flow rate of water through the membrane 67 to obtain a high quality drinking water product. A small cone-shaped screen (not shown) fits over the end of the flow control to help prevent the flow control from plugging with drain water sediments.

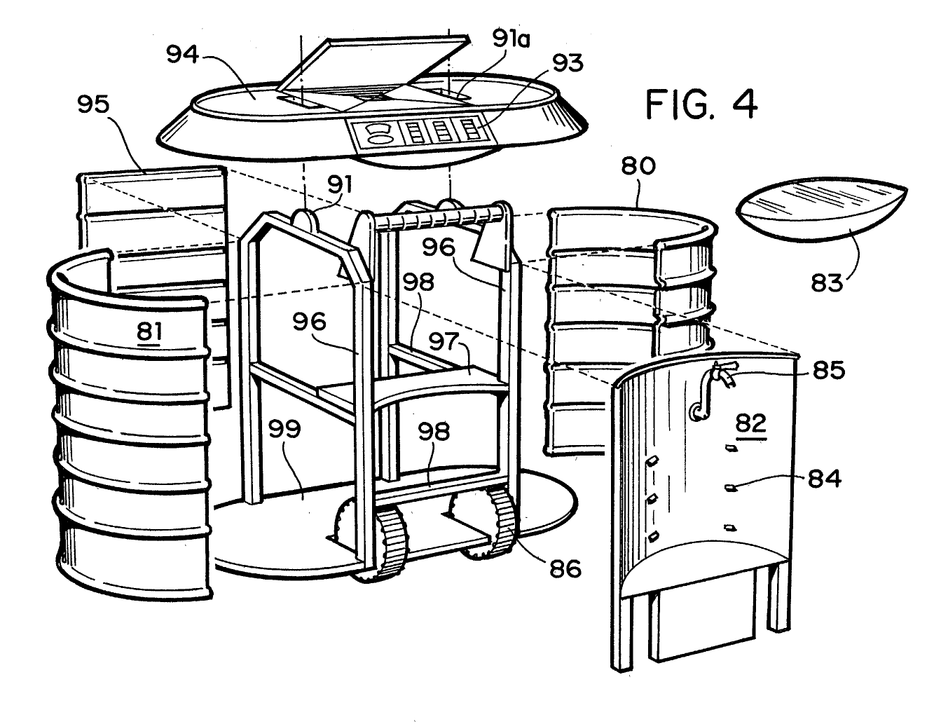

Turning now to FIG. 3 which illustrates a preferred and fully assembled container, although any other container can be used for practicing the invention. The container 12 consists of different panels that may be attached to a frame assembly shown in FIG. 4. To this end, there are two side panels, a left 81 and a right 80 panel, having the shape of a semi circle, although any other shape may be used. The side panels 80 and 81 may be molded from a high density polyethylene material. The side panels 80 and 81 could also be stamped out of a sheet metal material. It is believed that the molding process would save in material, labor and cost. The front panel 82 is preferred to be in a concave shape for esthetic reasons and for practical reasons. At 83 is shown a movable support shelf that is adjustable to different heights to accommodate a short drinking glass or a tall carafe for being filled from the spigot 85 which is connected by a line segment within the container 12 as was shown in FIGS. 1 and 2. The supports for the shelf 83 can be support clips or openings 84 in the concave wall 82. The container 12 itself is mobile by way of the wheels 86 which is similar to the well known trash containers. To operate the invention and thereby the container from different locations, a handle 87 is provided which aids in moving the container. The two side panels 80 and 81 exhibit reinforcing ridges 88 that are useful in adding stability and rigidity to the basic container. The container is topped off by a top cover or panel 94 which at its front has a control panel 93 which contains all of the various controls necessary for operating the device. The top panel 94 has openings 91a on two opposing sides to accommodate semicircular elements 91 which are placed on top of frame members 96 (FIG. 4). The elements 91 protrude through the top panel 94 to form a base for a frame assembly 89 mounted on top of the container. The frame assembly 89 consists of various struts of circular cross section that are interconnected by frame support nodes or otherwise known as miro ball connectors. The frame assembly obviously can be assembled in many different sizes and shapes. It all depends of the lengths of the various struts and the number of connector nodes being used. The frame assembly on top of the container 12 can support a multiple of solar panels 18 for the purpose as was described with reference to FIGS. 1 and 2. It is also quite possible to support a single and large solar panel on the frame assembly.

Turning now to FIG. 4, the basic frame assembly consists of right and left frame members 96 which are interconnected by cross pieces 98 and 99. Then there is a support shelf 97 which may support various items of the basic operating apparatus. The basic side panels 80, 81, rear panel 95 and top panel 94 are easily supported on the basic frame assembly by clips or pre molded tongue and grooves or dovetail fittings.

When the apparatus is not in use, the solar panels may conveniently be stored inside the container 12, or in the case of larger individual panels, the larger panels my be stored on the outside of the container by brackets mounted on the outside of the container

What I claim is;

1. A renewable stored energy generating apparatus comprising a fully contained and stand-alone container, said container containing one or more storage batteries for providing auxiliary power when required, one or more renewable energy sources connected to said storage batteries, a water filtration system being connected to an inlet of a pump, means for operating said pump by said storage batteries, an outlet of said pump is connected to an inlet of a fresh or salt water filter, said water filter includes an outlet that is connected to a water dispensing device, said apparatus is ready for operation except for a deployment of said renewable energy sources.

2. The apparatus of claim 1, wherein said renewable energy source comprises solar panels.

3. The apparatus of claim 1 including a first water holding tank connected to said outlet of said filter for storing filtered water therein.

4. The apparatus of claim 1 including a second water holding tank for receiving water to be filtered.

5. The apparatus of claim 1 including means for connecting said storage batteries to 12-Volt DC outlets.

6. The apparatus of claim 1 including means for converting said auxiliary power to a 110-Volt AC system.

7. The apparatus of claim 6 including means for connecting said 110-Volt AC system to 110-Volts AC outlets.

8. The apparatus of claim 1, wherein said water filtration system comprises a reverse osmosis system.

9. The apparatus of claim 1, wherein said water filtration system comprises a desalination system.

10. A water filtration apparatus that is self-contained within a stand-alone container, said apparatus including a renewable energy source located on said container and collecting electrical energy which is channeled to electric storage batteries, said electric batteries are electrically connected to a pump, said pump delivering water to a succession of filters from a storage tank, said pump further delivering filtered water from said filters to a holding tank and from there to a dispenser when needed

11. The apparatus of claim 10, wherein said renewable energy source includes one or more solar energy collector panels.

12. The apparatus of claim 10, wherein said succession of filters is part of a reverse osmosis system.

13. The apparatus of claim 10, wherein said succession of filters is part of a desalination system.

14. The apparatus of claim 1, wherein said container includes a multiple of panels which are fastened to a basic frame assembly.

15. The apparatus of claim 14, wherein said panels include two side panels, a rear panel, a front panel and a top cover panel.

16. The apparatus of claim 15, wherein said top cover has two openings at a top surface thereof and wherein a semicircular support element protrudes through each of said openings.

17. The apparatus of claim 16 including a frame support assembly having support struts and wherein at least struts are fastened to each of said semicircular support elements.

18. The apparatus of claim 17, wherein said frame support assembly forms a base for supporting said solar panels.
